(19) United States
(12) Patent Application Publication
(10) Pub. No.: US 2009/0022062 A1
(43) Pub. Date: Jan. 22, 2009

(54) METHOD AND APPARATUS FOR PERFORMING INTER-RADIO ACCESS TECHNOLOGY MEASUREMENTS TO SUPPORT GERAN BAND SCAN

(75) Inventors: Peter S. Wang, E. Setauket, NY (US); Jin Wang, Central Islip, NY (US); Marian Rudolf, Montreal (CA); Shankar Somasundaram, Deer Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/144,159

(22) Filed: Jun. 23, 2008

Related U.S. Application Data
(60) Provisional application No. 60/945,962, filed on Jun. 25, 2007.

(51) Int. Cl. H04J 3/14

(52) U.S. Cl. 370/252

(57) ABSTRACT

A method and apparatus for performing inter-radio access technology (RAT) measurements includes receiving a long term evolution (LTE) measurement quantity. A measurement gap is received. Measurements for available global system for mobile communication (GSM) cells are performed, and the measurement results are reported.

### CROSS REFERENCE TO RELATED APPLICATIONS

This application claims the benefit of U.S. Provisional Application No. 60/945,962, filed Jun. 25, 2007, which is incorporated by reference as if fully set forth.

### FIELD OF INVENTION

This application is related to wireless communications.

### BACKGROUND

The Third Generation Partnership Project (3GPP) has recently initiated a long term evolution (LTE) program to bring new technology, new network architecture, new configuration and new applications and services to the wireless cellular network in order to provide improved spectral efficiency and faster user experiences. In LTE, the reliance on the network-provided neighboring cell information is reduced in order to offload the network burdens and user equipments (UEs) may need to find neighboring cells in other RAT by itself or may be commanded by an eNodeB to locate neighboring base stations and cells or to collect their radio coverage conditions for the purpose of LTE access network self-configuration and self-optimization. Therefore, in an RRC_CONNECTED state, a measurement command and a measurement gap configuration may come for the UE to perform a global system for mobile communication (GSM) band scan/search task to locate or verify available GSM cells.

However, there is no current measurement quantity or measurement gap purpose allocated to a UE for a GSM Enhanced Data rates for Global Evolution (EDGE) radio access network (GERAN) band scan operation. A complete GERAN band scan or search for identifiable GSM cells may aid an LTE network to reduce broadcast signaling space on the GERAN neighboring cell list and may provide more accurate and timely GSM neighboring cell information.

In addition, in order to support the LTE self-configuration and self-optimization of an evolved Node B (eNB), individual user equipments may perform neighboring cell scans for the eNB. It would therefore be beneficial to provide a method and apparatus for performing inter-radio access technology (RAT) measurements to support a GERAN band scan.

### SUMMARY

A method and apparatus for performing inter-radio access technology (RAT) measurements is disclosed. The method includes receiving a long term evolution (LTE) measurement quantity. A measurement gap is received. Measurements for available global system for mobile communication (GSM/GERAN) cells are performed, and the measurement results are reported.

### BRIEF DESCRIPTION OF THE DRAWINGS

A more detailed understanding may be had from the following description, given by way of example in conjunction with the accompanying drawings wherein:

FIG. 1 shows an example wireless communication system including a plurality of wireless transmit/receive units (WTRUs) and an evolved Node B (eNB);

FIG. 2 is an example functional block diagram of a WTRU and the eNB of FIG. 1;

FIG. 3 is a flow diagram of a method for performing inter-RAT measurements;

FIG. 4 shows an example compressed mode gap pattern parameter; and

FIG. 5 shows an example diagram depicting gap distances.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

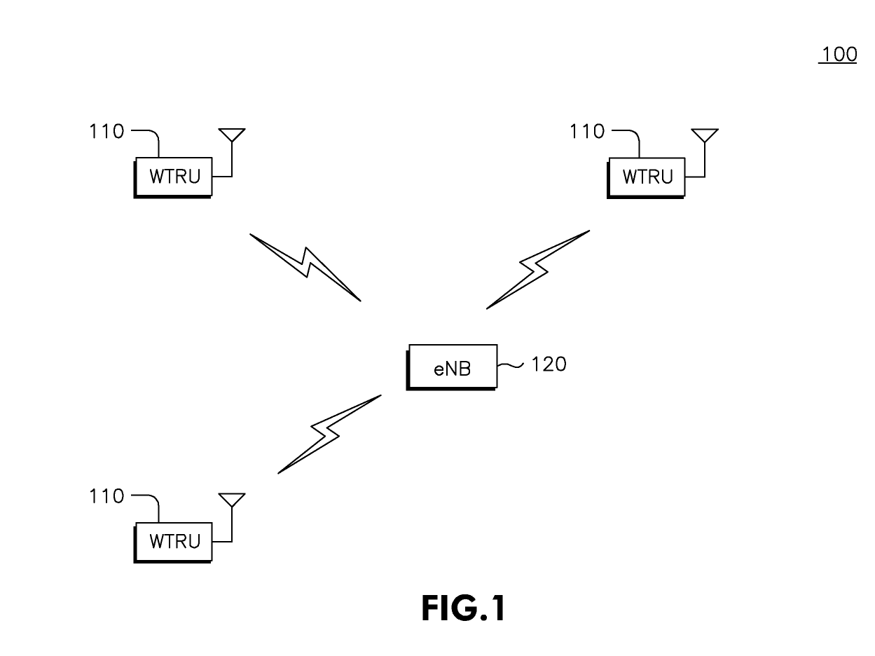

FIG. 1 shows an example wireless communication system 100 including a plurality of WTRUs 110, and an evolved Node B (eNB) 120. As shown in FIG. 1, the WTRUs 110 are in communication with the eNB 120. It should be noted that, although an example configuration of WTRUs 110 and an eNB 120 is depicted in FIG. 1, any combination of wireless and wired devices may be included in the wireless communication system 100. For example, although only one base station (eNB 120) is depicted in the wireless communication system 100, additional base stations may be present, such as in a GERAN system.

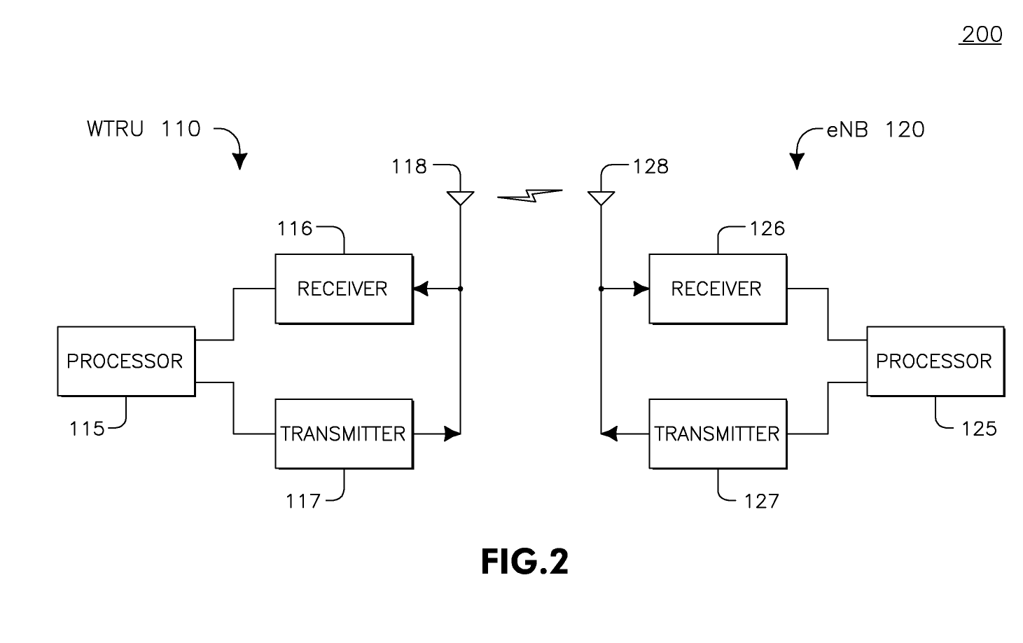

FIG. 2 is an example functional block diagram 200 of a WTRU 110 and the eNB 120 of the wireless communication system 100 of FIG. 1. As shown in FIG. 2, the WTRU 110 is in communication with the eNB 120.

In addition to the components that may be found in a typical WTRU, the WTRU 110 includes a processor 115, a receiver 116, a transmitter 117, and an antenna 118. The receiver 116 and the transmitter 117 are in communication with the processor 115. The antenna 118 is in communication with both the receiver 116 and the transmitter 117 to facilitate the transmission and reception of wireless data. The processor 115 of the WTRU 110 is configured to perform inter-RAT measurements to support GERAN band scan, and may be an LTE WTRU.

In addition to the components that may be found in a typical Node B, the eNB 120 includes a processor 125, a receiver 126, a transmitter 127, and an antenna 128. The receiver 126 and the transmitter 127 are in communication with the processor 125. The antenna 128 is in communication with both the receiver 126 and the transmitter 127 to facilitate the transmission and reception of wireless data.

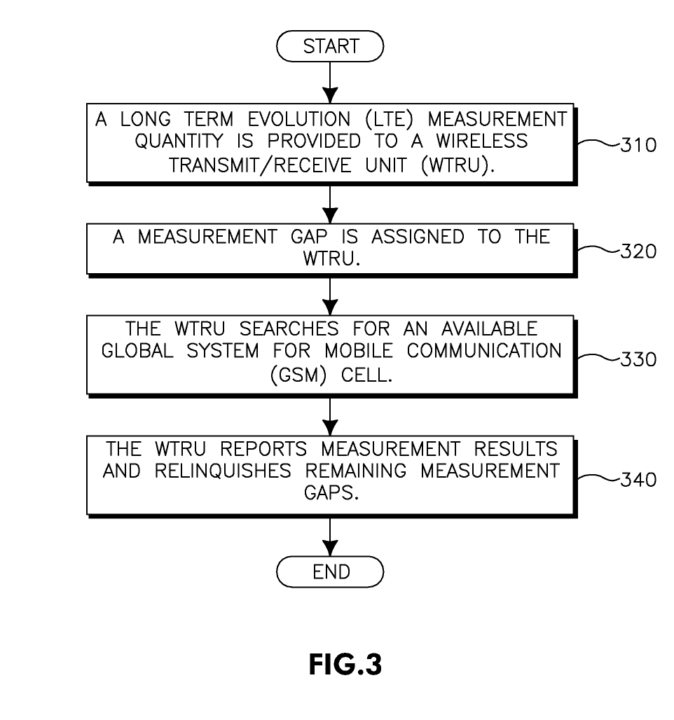

FIG. 3 is a flow diagram of a method 300 for performing inter-RAT measurements. In step 310, an LTE measurement quantity is provided to the WTRU 110. This measurement quantity may aid the WTRU 110 in performing a neighboring cell scan for the eNB 120. In order to provide this measurement quantity, an E-UTRAN may set a corresponding measurement quantity for inter-RAT measurements. Table 1 below shows an example table format.

TABLE 1

| | Information Element | | | |
|---|---|---|---|---|
| Group name | Need | Multi | Type and reference | Semantics description |
| Measurement quantity for | OP | | Intra-frequency measurement | |
| UTRAN quality estimate | | | quantity 10.3.7.38 | |
| CHOICE system | MP | | | |
| >GSM | | | | |
| >>Measurement quantity | MP | | Enumerated(GSM Carrier | When the measurement quantity |
| | | | RSSI, GSM Band Scan/Search) | is GSM Band Scan/Search, the UE |
| | | | | at provided measurement gaps |
| | | | | searches the GSM band(s) that it |
| | | | | supports (see Classmark-II or |
| | | | | Classmark-III that the UE has |
| | | | | indicated to the network) for |
| | | | | available GSM cells |
| >>Filter coefficient | MP | | Filter coefficient 10.3.7.9 | |
| >>BSIC verification required | MP | | Enumerated(required, | |
| | | | not required) | |
| >IS2000 | | | | |
| >>TADD E_{c}/I₀ | MP | | Integer(0 . . . 63) | Admission criteria for neighbours, |
| | | | | see subclause 2.6.6.2.6 of |
| | | | | TIA/EIA/IS-2000.5 |
| >>TCOMP E_{c}/I₀ | MP | | Integer(0 . . . 15) | Admission criteria for neighbours, |
| | | | | see subclause 2.6.6.2.5.2 of |
| | | | | TIA/EIA/IS-2000.5 |
| >>SOFT SLOPE | OP | | Integer(0 . . . 63) | Admission criteria for neighbours, |
| | | | | see subclause 2.6.6.2.3 and |
| | | | | 2.6.6.2.5.2 of TIA/EIA/IS-2000.5 |
| >>ADD_INTERCEPT | OP | | Integer(0 . . . 63) | Admission criteria for neighbours, |
| | | | | see subclause 2.6.6.2.5.2 of |
| | | | | TIA/EIA/IS-2000.5 |

It should be noted that Table 1 is an example format using a UMTS table as an example.

A measurement gap is then assigned to the WTRU 110 (step 320). In order to achieve this, a purpose entry may be set for the GERAN band scan or search. Table 2 below shows an example purpose entry setting for GSM Band Scan/Search.

TABLE 2

| | | | |
|---|---|---|---|
| >Transmission | OP | | |
| gap pattern | | | |
| sequence | | | |
| configuration | | | |
| parameters | | | |
| >>TGMP | MP | Enumerated(TDD measurement, | Transmission |
| | | FDD measurement, GSM carrier | Gap pattern |
| | | RSSI measurement, GSM Initial | sequence |
| | | BSIC identification, GSM BSIC | Measurement |
| | | re-confirmation, Multi-carrier | Purpose. |
| | | measurement, GSM Band | |
| | | Scan/Search) | |

The E-UTRAN may assign to the WTRU 110 measurement gaps with longer gap lengths for the purpose of GSM Band Scan, (e.g., TGL1 and TGL2 could be different) with a patterned varying transmit gap distance (TGD) in order for the WTRU 110 to adjust its alignment to different frame timings of the frequency correction channel (FCCH) and synchronization channel (SCH) from different GSM cells.

Patterned varying TGDs may indicate the time between measurement gaps, (e.g., gap-1 and gap-2), and vary in distance lengths in a fixed way within the pattern repetition length (TGPL1). For example, a pattern may be ABCABC, where A is equal to ten subframes, B is equal to 6 subframes and C is equal to 15 subframes. The values of A, B and C can be specified in the TGD sub-fields of a TGD-pattern to depict the repeating varying gap distances between gap-1 and gap-2 until TGPRC is done. This pattern can be predefined, such as in Standards or it could be determined by the network and signaled to the WTRU 110. Table 3 below shows a predefined gap pattern.

TABLE 3

| | | | | |
|---|---|---|---|---|
| >Transmission gap | OP | | | |
| pattern sequence | | | | |
| configuration parameters | | | | |
| >>TGMP | MP | | Enumerated(TDD measurement, FDD | Transmission Gap pattern |
| | | | measurement, GSM carrier RSSI | sequence Measurement Purpose. |
| | | | measurement, GSM Initial BSIC | |
| | | | identification, GSM BSIC re-confirmation, | |
| | | | Multi-carrier measurement, GSM Band | |
| | | | Scan/Search) | |
| >>TGPRC | MP | | Integer | The number of transmission |
| | | | | gap patterns within the |
| | | | | Transmission Gap Pattern |
| | | | | Sequence. |
| >>TGSN | MP | | Integer | Transmission Gap Starting |
| | | | | Slot Number |
| | | | | The slot number |
| | | | | of the first transmission |
| | | | | gap slot within the TGCFN. |
| >>TGL1 | MP | | Integer | The length of the first |
| | | | | Transmission Gap within the |
| | | | | transmission gap pattern |
| | | | | expressed in number of slots |
| >>TGL2 | MD | | Integer | The length of the second |
| | | | | Transmission Gap within the |
| | | | | transmission gap pattern. If |
| | | | | omitted, then TGL2 = TGL1. |
| | | | | The value of TGL2 shall be |
| | | | | ignored if TGD is set to “undefined” |
| >> TGD-pattern | | Integer | | One or more Transmission gap |
| | | (1, . . . maxTGDs, | | distances as a repeating |
| | | undefined) | | pattern in the transmitted order |
| | | | | of the following TGDs indicating |
| | | | | the number of LTE sub-frames |
| | | | | between starting slots of two |
| | | | | consecutive transmission gaps |
| | | | | within a transmission gap pattern. |
| | | | | If there is only one transmission |
| | | | | gap in the transmission gap pattern, |
| | | | | this parameter shall be set to |
| | | | | “undefined”. |
| >>>TGD | MP | | Integer | |
| | | | (10, . . . maxTGD) | |
| >>TGPL1 | MP | | Integer | The duration of transmission gap |
| | | | (1 . . . maxPatternDuration) | pattern 1 in number of frames. |

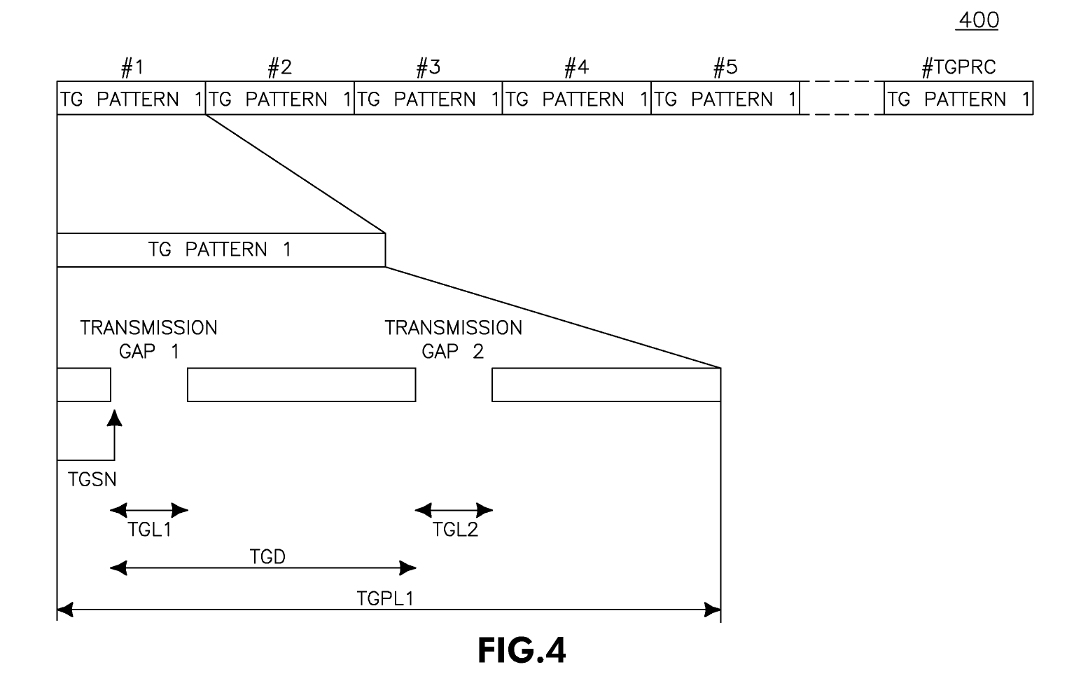

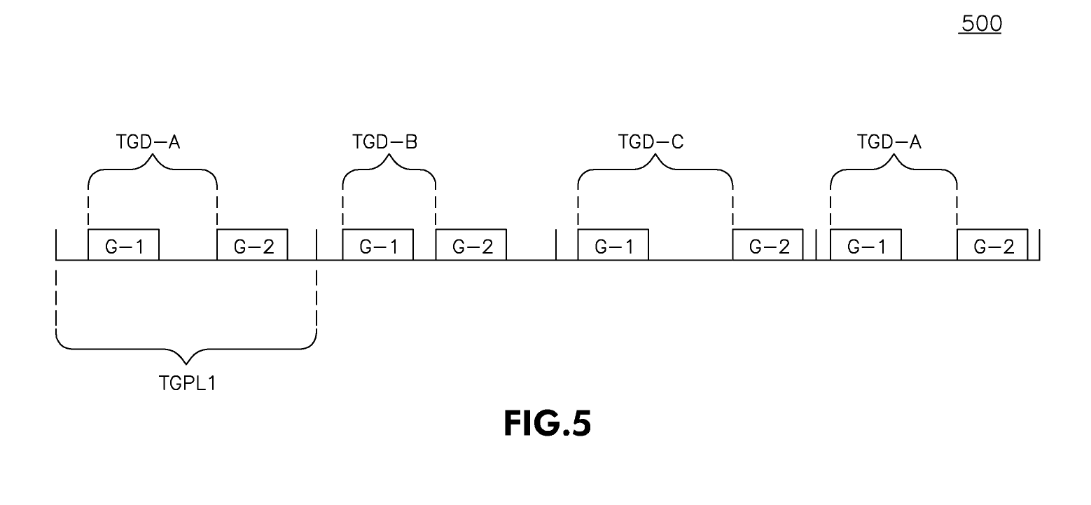

FIG. 4 shows an example compressed mode gap pattern parameter 400. FIG. 5 shows an example diagram depicting gap distances 500. As shown in FIGS. 4 and 5, gap-1 and gap-2 are of different gap lengths. There are 3 TGDs in the TGD-pattern, A, B and C. As shown in the Figures, the distance between the beginning of gap-1 and the beginning of gap-2 varies from A to B to C and back to A and such within the TGPL1.

In step 330, the WTRU 110 searches for an available GSM cell, for example, when the inter-RAT (GERAN) measurement commands the WTRU 110 for “GERAN band scan/search”. The WTRU 110 schedules the GSM band search, (e.g., on the supported GSM frequencies indicated in its Classmark-II/Classmark-III or their LTE equivalent to the network), during the measurement gap allocated in step 320 by the LTE network for the specific “GERAN band scan/search” purpose.

In one example, the scan/search includes the WTRU 110 tuning to each relevant specific absolute radio frequency channel number (ARFCN) within the band, measuring the waveform to determine whether or not it is above a predefined threshold, synchronizing with the FCCH and SCH of the GSM cell, acquiring the base station identity code (BSIC), and the carrier GSM received signal strength indicator (RSSI). In addition, the WTRU 110 may acquire the public land mobile network identity (PLMN-ID).

Once an available cell is identified and measurements are completed with respect to that cell, the WTRU 110 may continue to scan/search for the next available GSM frequency/cell, (e.g., using the ARFCN increment approach), with the remaining time of the same measurement gap pattern in the same band until exhausted. For example, when there are no more GSM frequencies in the supported band(s) or when the allocated total length of the gap pattern is depleted.

If the WTRU 110 supports more than one GERAN band, the WTRU 110 may also use the remaining time of the same measurement gap pattern to continue searching for GSM cells in a different GERAN band until the assigned time is exhausted. The WTRU 110 may complete measurements at the end of a whole measurement gap pattern or at the end of a period specified by the E-UTRAN.

Once the GERAN band scan/search is complete, the WTRU 110 reports the measurement results along with an indication of the completion of the measurement to the E-UTRAN, and relinquishes any subsequent remaining gaps (step 340). Some of the data that the WTRU 110 may report are the GERAN/GSM band, (e.g., GSM 850, P-GSM900, DCS 1800, PCS 1900, and the like), the ARFCN for available cells found, or the GSM carrier RSSI for the ARFCN. Additionally, the WTRU 110 may report the BSIC for the GSM cell, the PLMN-ID for the GSM cell, or the measured RXLEV and/or RXQUAL for the GSM cell. The WTRU 110 may also indicate that measurements are completed.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for performing inter-radio access technology (RAT) measurements, comprising:
receiving a long term evolution (LTE) measurement quantity;
receiving a measurement gap;
measuring for available global system for mobile communication (GSM) cells; and
reporting measurement results.

2. The method of claim 1, further comprising relinquishing a measurement gap.

3. The method of claim 1, further comprising receiving a command to perform a measurement of available GSM cells.

4. The method of claim 1 wherein the measurement results reported include any one of the following: a GSM Enhanced Data rates for Global Evolution (EDGE) radio access network (GERAN) band, a GSM band, an absolute radio frequency channel number (ARFCN) for an available cell, and a GSM carrier received signal strength indicator (RSSI) for an available cell.

5. The method of claim 1 wherein the measurement results reported include any one of the following: a base station identity code (BSIC), and a public land mobile network identity (PLMN-ID).

6. The method of claim 1 wherein when a cell is identified during measuring for available GSM cells, the measuring continues until another available cell is found.

7. The method of claim 6 wherein the measuring is performed in the same GERAN band.

8. The method of claim 6 wherein the measuring is performed in a different GERAN band.

9. The method of claim 1, further comprising indicating that measuring is complete.

10. The method of claim 1, further comprising adjusting alignment to frame timings of GSM cells.

11. The method of claim 10 wherein frame timings are adjusted to any one of the following: a frequency correction channel (FCCH), and a synchronization channel (SCH).

12. A wireless transmit/receive unit (WTRU), comprising:
a receiver;
a transmitter; and
a processor in communication with the receiver and the transmitter, the processor configured to receive a long term evolution (LTE) measurement quantity, receive a measurement gap, measure for available global system for mobile communication (GSM) cells, and reporting measurement results.

13. The WTRU of claim 12 wherein the processor is further configured to relinquishing a measurement gap.

14. The WTRU of claim 12 wherein the processor is further configured to receive a command to perform a measurement of available GSM cells.

15. The WTRU of claim 12 wherein the processor is further configured to indicate that measuring is complete.

16. The WTRU of claim 12 wherein the processor is further configured to adjust alignment to frame timings of GSM cells.

17. An evolved Node B (eNB), comprising:
a receiver;
a transmitter; and
a processor in communication with the receiver and the transmitter, the processor configured to assign a long term evolution (LTE) measurement quantity, assign a measurement gap, signal the LTE measurement quantity and measurement gap to a wireless transmit/receive unit (WTRU), and command the WTRU to measure for available global system for mobile communication (GSM) cells.

18. The eNB of claim 17 wherein the processor is further configured to receive a measurement report from the WTRU.

19. The eNB of claim 18 wherein the processor is further configured to reallocate resources to at least one other WTRU based upon the measurement report.
